(19) United States
(12) Patent Application Publication
(10) Pub. No.: US 2011/0151297 A1
(43) Pub. Date: Jun. 23, 2011

(54) BATTERY AND BATTERY PACK

(76) Inventors: Keisuke Shimizu, Osaka (JP); Tomohiko Yokoyama, Osaka (JP); Masato Fujikawa, Osaka (JP)

(21) Appl. No.: 13/060,208

(22) PCT Filed: May 21, 2010
(86) PCT No.: PCT/JP2010/003449

§ 371 Date: Feb. 22, 2011

(30) Foreign Application Priority Data
Jun. 22, 2009 (JP) 2009-147452

(51) Int. Cl. H01M 2/10; H01M 2/02; H01M 10/36

(52) U.S. Cl. 429/94; 429/163; 429/99

(57) ABSTRACT

A battery pack includes a plurality of batteries 12, and a pack case 13 containing the batteries 12. An electrode group is placed in a battery case 11, and an opening of the battery case 11 is sealed by a sealing plate 9. A first internal lead 6 electrically connected to one of positive and negative electrodes is connected to an inner bottom surface of the battery case 11. A second internal lead electrically connected to the other one of the positive and negative electrodes is connected to the sealing plate. The first internal lead 6 is arranged near an inner side surface of the battery case 11. Each of the batteries 12 is arranged in the pack case 13 with part of an outer side surface of the battery case 11 corresponding to the first internal lead 6 facing the inner side surface of the pack case 13.

### TECHNICAL FIELD

The present invention relates to a battery and a battery pack, particularly to a battery including an internal lead which electrically connects a battery case and an electrode group, and a battery pack containing the battery.

### BACKGROUND ART

A conventional battery in which an electrode group including a positive electrode, a negative electrode, and a separator is placed in a battery case together with an electrolyte solution, and a sealing plate seals an opening of the battery case has been used. The battery includes a negative electrode internal lead for electrically connecting the negative electrode and an inner bottom surface of the battery case, and a positive electrode internal lead for electrically connecting the positive electrode and the sealing plate.

A conventional battery pack containing a plurality of batteries in a pack case has been used.

When an external short circuit occurs in a battery, a short circuit current flows in the battery, and Joule heat is generated in the battery, thereby increasing battery temperature. Due to the Joule heat, chemical reaction is promoted in the electrode group to generate heat of reaction, and the battery temperature further increases. This may result in overheat of the battery.

When the external short circuit occurs in one or more batteries contained in the pack case of the battery pack, what is important for ensuring safety of the battery is to dissipate heat generated by the external short circuit caused in the battery outside the battery, thereby preventing the overheat of the battery.

Various technologies to dissipate the heat generated by the batteries contained in the pack case of the battery pack have been proposed.

For example, according to a first proposed technology, a battery group of a plurality of cylindrical batteries is sandwiched between a pair of heat dissipating plates to bring the outer circumferential surfaces of the batteries into contact with the inner surfaces of the heat dissipating plates, while exposing outer surfaces of the heat dissipating plates outside the battery pack (see, e.g., Patent Document 1). This allows transfer of the heat generated by the batteries to the heat dissipating plates, thereby dissipating the heat outside the battery pack.

According to a second proposed technology, for example, part of an external lead connected to end faces of the cylindrical batteries is protruded outside the battery pack (see, e.g., Patent Document 2). This allows transfer of the heat generated by the batteries to the external lead, thereby dissipating the heat outside the battery pack.

### CITATION LIST

### Patent Document

Patent Document 1: Japanese Patent Publication No. 2002-124225

Patent Document 2: Japanese Patent Publication No. 2005-317456

### SUMMARY OF THE INVENTION

### Technical Field

According to the technology taught by Patent Document 1, the battery group is sandwiched between the pair of heat dissipating plates. This is disadvantageous because the weight of the battery pack increases.

The technology taught by Patent Document 2 is also disadvantageous for the following reason. The external lead is connected to the end faces of the batteries, and is capable of effectively dissipating heat of the end faces of the batteries outside the battery pack. However, heat of the circumferential surfaces of the batteries cannot effectively be dissipated outside the battery pack. Thus, the heat generated from the whole parts of the batteries cannot effectively be dissipated outside the batteries.

In view of the foregoing, an object of the invention is to effectively dissipate heat, which is generated due to an external short circuit caused in one or more batteries contained in a pack case of a battery pack, to the pack case without increasing the weight of the battery pack. This allows effective dissipation of the heat generated in the battery which experienced the external short circuit to the outside of the batteries, thereby ensuring safety of the batteries, and safety of the battery pack.

### Solution to the Problem

To achieve the above-described object, the inventors of the present invention have conducted various studies as described later, and have found that a first internal lead and a second internal lead generate heat when the external short circuit occurs in the battery, and in particular, the first internal lead connected to a battery case significantly generates heat. Based on the finding, the inventors of the present invention have found that the heat generated by the first internal lead should efficiently be dissipated to a pack case (in particular, a pack case having a heat dissipating property (i.e., high thermal conductivity, high specific heat capacity, etc.)) in order to achieve the above-described object. This can reduce the possibility of overheat of the battery which experienced the external short circuit, thereby ensuring safety of the battery, and safety of the battery pack.

To achieve the above-described object, the present invention has been achieved based on the findings of the inventors of the present invention. Specifically, a battery of the invention is a battery contained in a pack case of a battery pack including: an electrode group which includes a positive electrode and a negative electrode wound or stacked with a porous insulating layer interposed therebetween, and is placed in a battery case together with an electrolyte solution, an opening of the battery case being sealed by a sealing plate; a first internal lead which is electrically connected to one of the positive electrode and the negative electrode, and is connected to an inner bottom surface of the battery case; and a second internal lead which is electrically connected to the other one of the positive electrode and the negative electrode, and is connected to the sealing plate, wherein the first internal lead is arranged near an inner side surface of the battery case, and an indicator for indicating the position of the first internal lead contained in the battery case is provided.

In the battery of the present invention, the position of the first internal lead contained in the battery case is can be found based on the indicator. Accordingly, in placing the battery of the present invention in a pack case of a battery pack, the first internal lead can be arranged near the pack case based on the position of the first internal lead indicated by the indicator. Thus, even when the external short circuit occurs in the battery in the pack case, and the first internal lead generates heat, the heat generated by the first internal lead can be transferred to the battery case which is thermally conductive, thereby efficiently dissipating the heat to the pack case. In particular, when the pack case has a heat dissipating property, the heat can be dissipated more efficiently to the pack case.

Thus, in a battery pack containing the battery of the present invention in a pack case, the possibility of the overheat of the battery which experienced the external short circuit can be reduced, thereby ensuring safety of the battery, and safety of the battery pack.

With the first internal lead arranged near the pack case, the heat generated in the battery which experienced the external short circuit (in particular, the heat generated by the first internal lead) can efficiently be dissipated to the pack case as described above. Specifically, the heat generated in the battery which experienced the external short circuit can efficiently be dissipated outside the battery. Different from the technology taught by Patent Document 1, there is no need to provide an additional special component (i.e., a pair of heat dissipating plates), and the weight of the battery pack would not increase.

In the battery of the present invention, the first internal lead is preferably a negative electrode internal lead which is electrically connected to the negative electrode, and the second internal lead is preferably a positive electrode internal lead which is electrically connected to the positive electrode.

With this configuration, when the battery is contained in the pack case, the heat significantly generated by the negative electrode internal lead due to the external short circuit caused in the battery can be transferred to the battery case, thereby efficiently dissipating the heat to the pack case.

In the battery of the present invention, the electrode group preferably includes the positive electrode and the negative electrode wound with the porous insulating layer interposed therebetween, one of the electrodes to which the first internal lead is electrically connected preferably includes a current collector, and an active material layer which is formed on a surface of the current collector to expose part of the surface of the current collector, the first internal lead is preferably connected to the part of the current collector exposed from the active material layer formed on the surface of the current collector, and the exposed part of the current collector is preferably positioned at a last wound end of the electrode to which the first internal lead is electrically connected.

With this configuration, the exposed part of the current collector is provided at the last wound end of the electrode to which the first internal lead is electrically connected. Thus, the first internal lead connected to the exposed part of the current collector is arranged near the inner side surface of the battery case.

In the battery of the present invention, the indicator is preferably provided on an outer surface of the sealing plate.

With this configuration, the position of the first internal lead contained in the battery case is can be found based on the indicator provided on the outer surface of the sealing plate.

In the battery of the present invention, the indicator is preferably a print which is printed on part of the outer surface of the sealing plate corresponding to the first internal lead.

In the battery of the present invention, the indicator is preferably provided on an outer side surface of the battery case.

With this configuration, the position of the first internal lead contained in the battery case can be found based on the indicator provided on the outer side surface of the battery case.

In the battery of the present invention, the indicator is preferably a print which is printed on part of the outer side surface of the battery case corresponding to the first internal lead.

In the battery of the present invention, the battery case is preferably cylindrical, and the indicator is preferably a flat portion provided in part of the outer side surface of the battery case corresponding to the first internal lead.

In the battery of the present invention, the indicator is preferably a raised portion which is provided in part of the outer side surface of the battery case corresponding to the first internal lead.

In the battery of the present invention, the indicator is preferably provided on an outer bottom surface of the battery case.

With this configuration, the position of the first internal lead contained in the battery case can be found based on the indicator provided on the outer bottom surface of the battery case.

In the battery of the present invention, the indicator is preferably a weld mark which remains on part of the outer bottom surface of the battery case corresponding to the first internal lead.

With this configuration, the weld mark which is left on the outer bottom surface of the battery case when the first internal lead is connected to the inner bottom surface of the battery case can be used as the indicator. This eliminates the need to perform a process of providing the indicator.

In order to achieve the above-described object, the present invention has been achieved based on the findings of the inventors of the present invention. Specifically, a battery pack of the present invention is a battery pack including a plurality of batteries, and a pack case containing the plurality of batteries, each of the batteries including: an electrode group which includes a positive electrode and a negative electrode wound or stacked with a porous insulating layer interposed therebetween, and is placed in a battery case together with an electrolyte solution, an opening of the battery case being sealed by a sealing plate; a first internal lead which is electrically connected to one of the positive electrode and the negative electrode, and is connected to an inner bottom surface of the battery case; and a second internal lead which is electrically connected to the other one of the positive electrode and the negative electrode, and is connected to the sealing plate, wherein the first internal lead is arranged near an inner side surface of the battery case, and each of the plurality of batteries is arranged in such a manner that part of the outer side surface of the battery case corresponding to the first internal lead faces an inner side surface of the pack case.

According to the battery pack of the present invention, each of the batteries is arranged in the pack case in such a manner that part of the outer side surface of the battery case corresponding to the first internal lead faces the inner side surface of the pack case. Thus, the first internal lead can be arranged near the pack case. Therefore, even when the external short circuit occurs in the battery, and the first internal lead generates heat, the heat generated by the first internal lead can be transferred to the battery case which is thermally conductive, thereby efficiently dissipating the heat to the pack case. In particular, when the pack case has a heat dissipating property, the heat can be dissipated more efficiently to the pack case.

Thus, in the battery pack of the present invention, the possibility of overheat of the battery which experienced the external short circuit can be reduced, thereby ensuring safety of the battery, and safety of the battery pack.

With the first internal lead arranged near the pack case, the heat generated in the battery which experienced the external short circuit (in particular, the heat generated by the first internal lead) can efficiently be dissipated to the pack case as described above. Specifically, the heat generated in the battery which experienced the external short circuit can efficiently be dissipated outside the battery. Different from the technology taught by Patent Document 1, there is no need to provide an additional special component (i.e., a pair of heat dissipating plates), and the weight of the battery pack would not increase.

In the battery pack of the present invention, each of the batteries is preferably placed in the pack case in such a manner that part of the outer side surface of the battery case corresponding to the first internal lead contacts the inner side surface of the pack case.

The battery pack of the present invention preferably includes a heat dissipator comprising a heat dissipating member which is provided on part of the outer side surface of the battery case corresponding to the first internal lead.

With this configuration, even when the external short circuit occurs in the battery, and the first internal lead generates heat, the heat generated by the first internal lead can be transferred to the battery case, thereby efficiently dissipating the heat to the heat dissipator. Thus, the heat efficiently dissipated to the heat dissipator can efficiently be dissipated to the pack case.

In the battery pack of the present invention, the pack case is preferably comprised of a heat dissipating member.

In the battery pack of the present invention, each of the plurality of batteries includes an indicator for indicating the position of the first internal lead contained in the battery case.

With this configuration, the position of the first internal lead contained in the battery case can be found based on the indicator. Thus, based on the position of the first internal lead indicated by the indicator, each of the batteries can be placed in the pack case in such a manner that part of the outer side surface of the battery case corresponding to the first internal lead faces the inner side surface of the pack case.

In the battery pack of the present invention, the indicator is preferably provided on an outer surface of the sealing plate.

With this configuration, even after the batteries are placed in the pack case in the fabrication of the battery pack, the outer surface of the sealing plate can be observed from an opening of the pack case. Thus, the position of the first internal lead can be found based on the indicator provided on the outer surface of the sealing plate (however, the position of the first internal lead is no longer found after the opening of the pack case is closed).

In the battery pack of the present invention, the indicator is preferably provided on an outer side surface of the battery case.

In the battery pack of the present invention, the indicator is preferably provided on an outer bottom surface of the battery case.

### Advantages of the Invention

According to the battery of the present invention, the position of the first internal lead contained in the battery case can be found based on the indicator. Therefore, when the battery of the present invention is placed in the pack case of the battery pack, the first internal lead can be arranged near the pack case based on the position of the first internal lead indicated by the indicator.

According to the battery pack of the present invention, each of the batteries is placed in the pack case in such a manner that part of the outer side surface of the battery case corresponding to the first internal lead faces the inner side surface of the pack case. Thus, the first internal lead can be arranged near the pack case.

Therefore, even when the external short circuit occurs in the battery placed in the pack case, and the first internal lead generates heat, the heat generated by the first internal lead can be transferred to the battery case which is thermally conductive, thereby efficiently dissipating the heat to the battery pack.

Thus, in the battery pack containing the battery of the present invention, and the battery pack of the present invention, the possibility of overheat of the battery which experienced the external short circuit can be reduced, thereby ensuring safety of the battery, and safety of the battery case.

With the first internal lead arranged near the pack case, the heat generated in the battery which experienced the external short circuit (in particular, the heat generated by the first internal lead) can efficiently be dissipated to the pack case as described above. Specifically, the heat generated in the battery which experienced the external short circuit can efficiently be dissipated outside the battery. Different from the technology taught by Patent Document 1, there is no need to provide an additional special component (i.e., a pair of heat dissipating plates), and the weight of the battery pack would not increase.

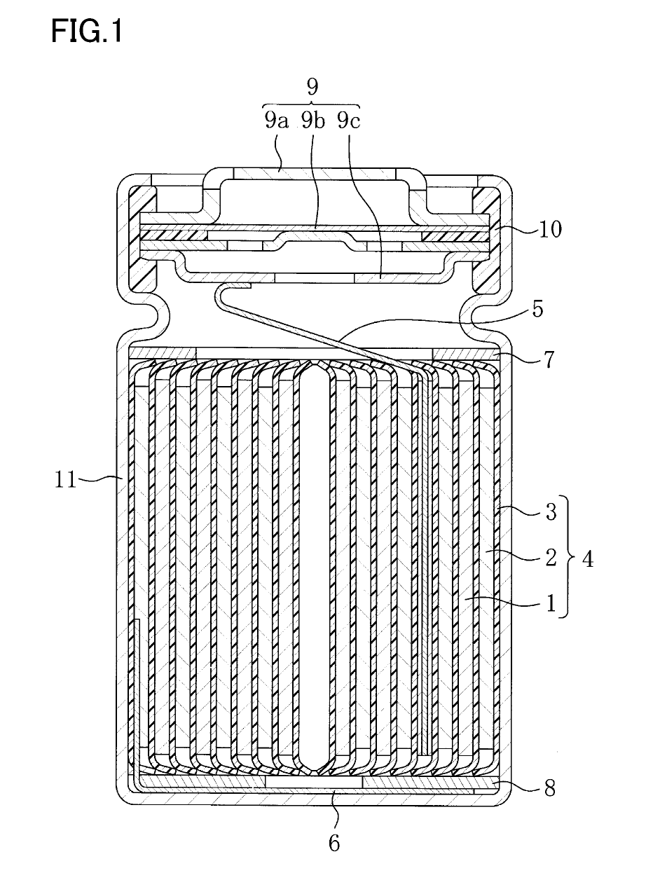

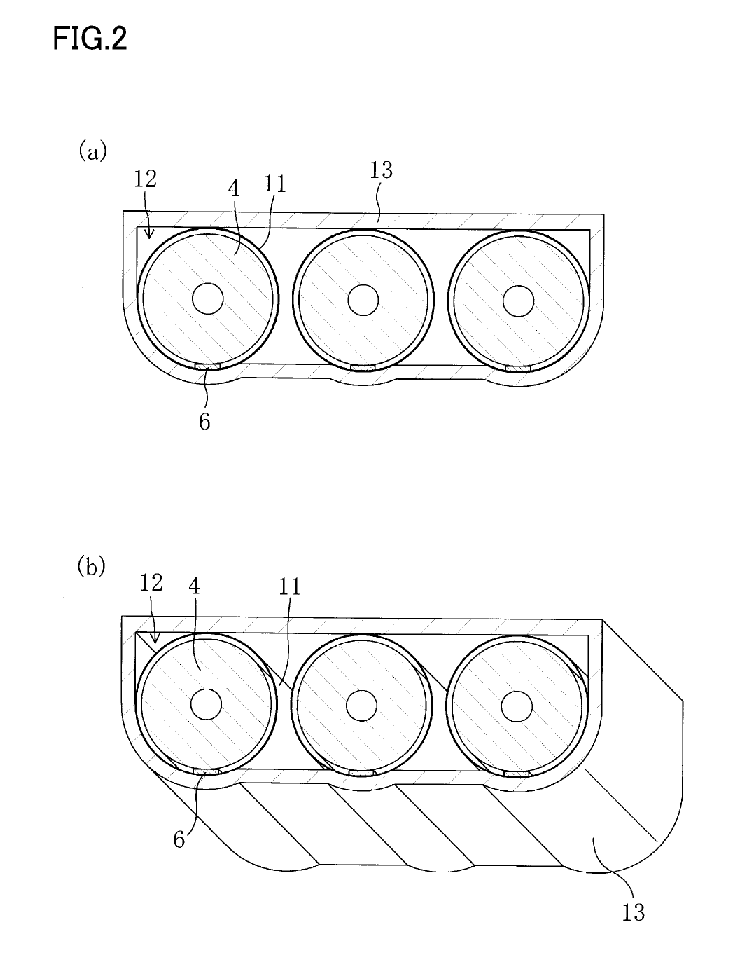

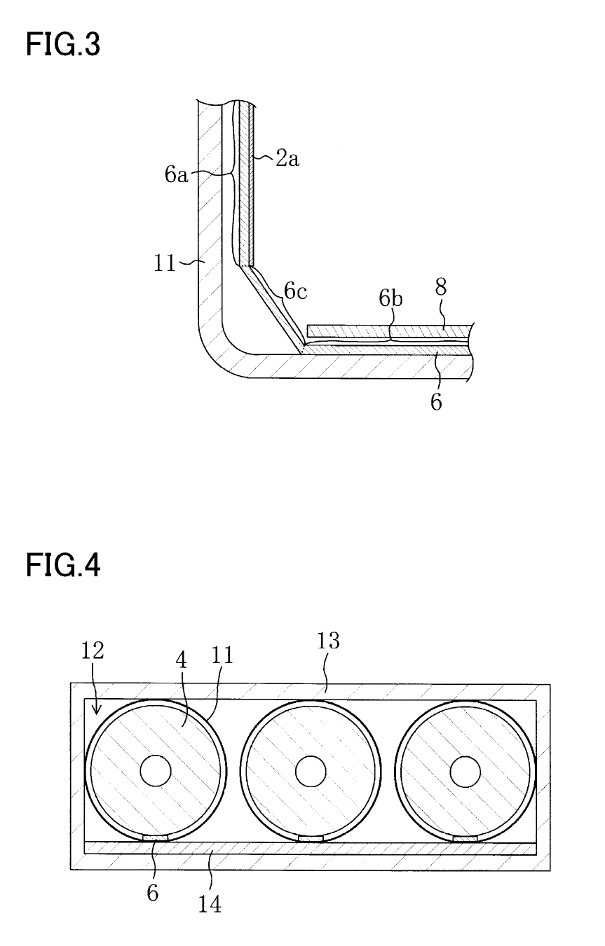

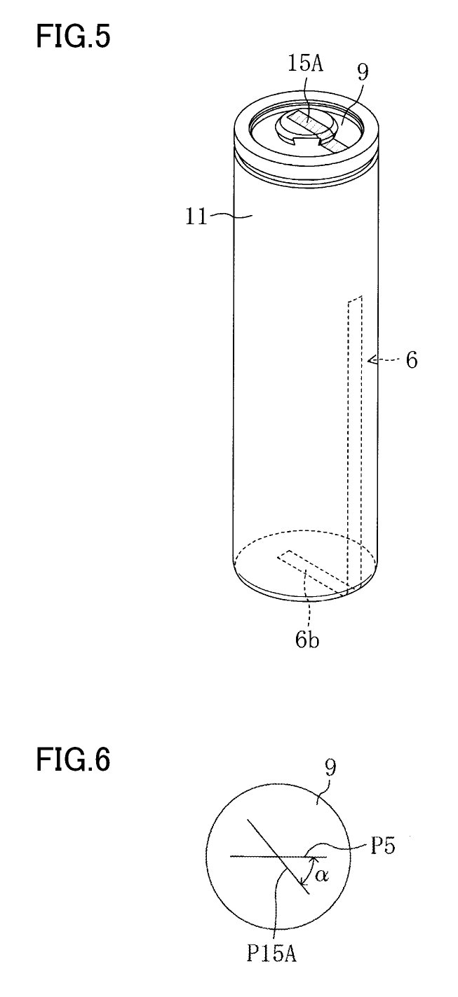

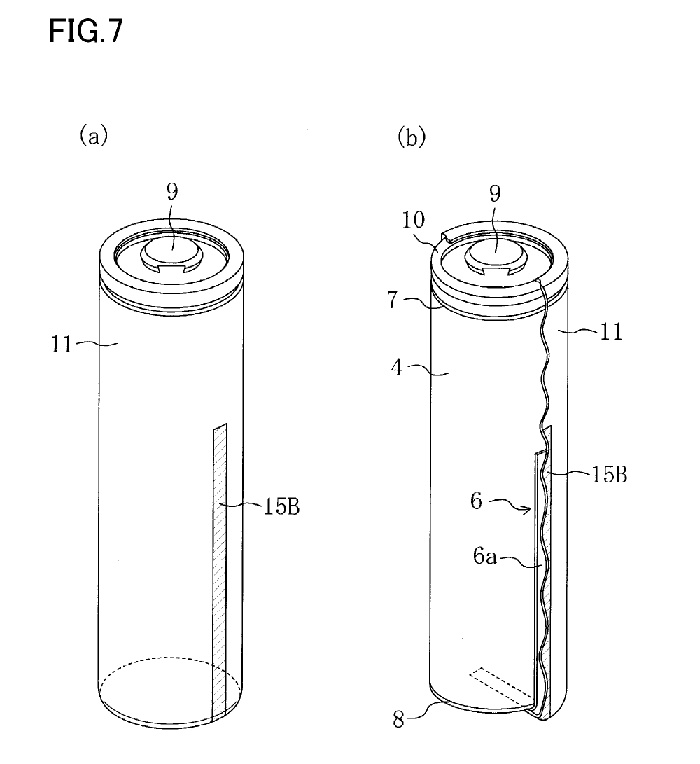

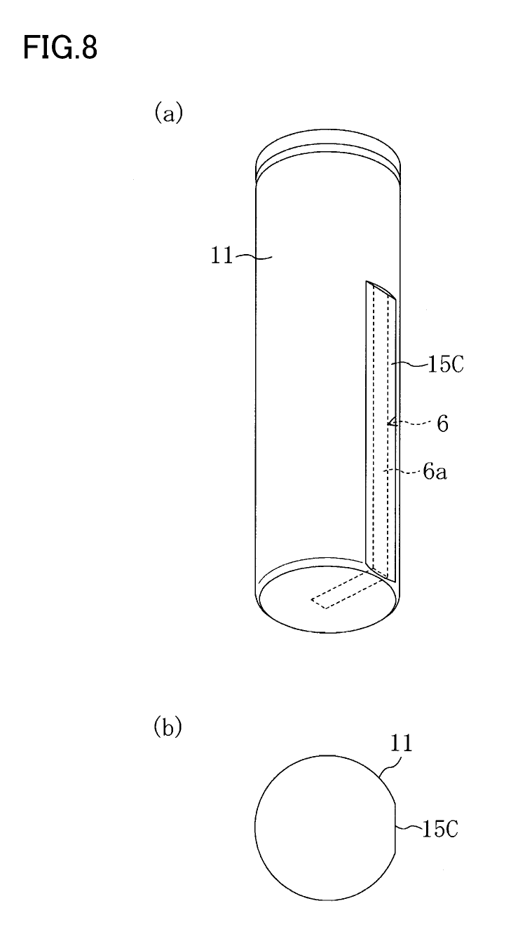

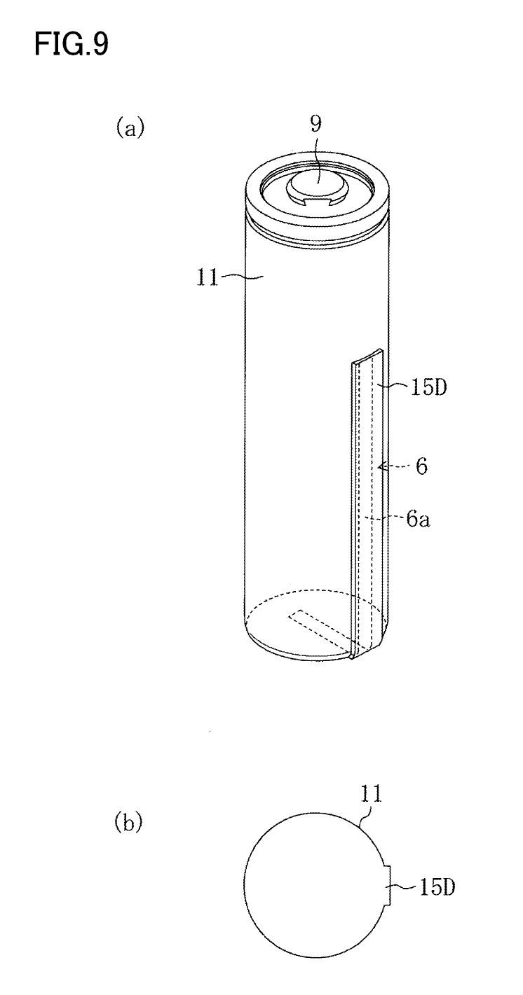

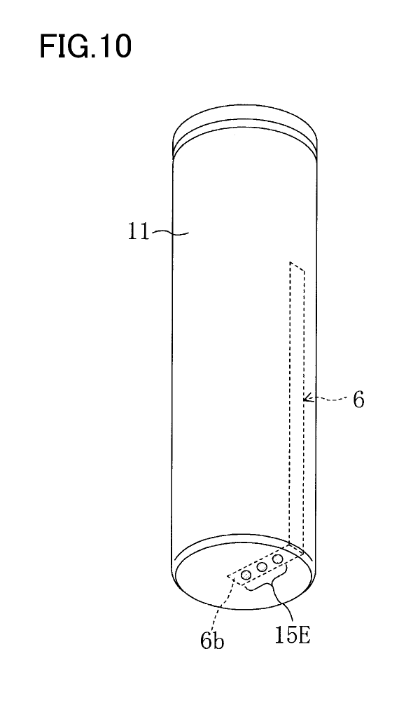

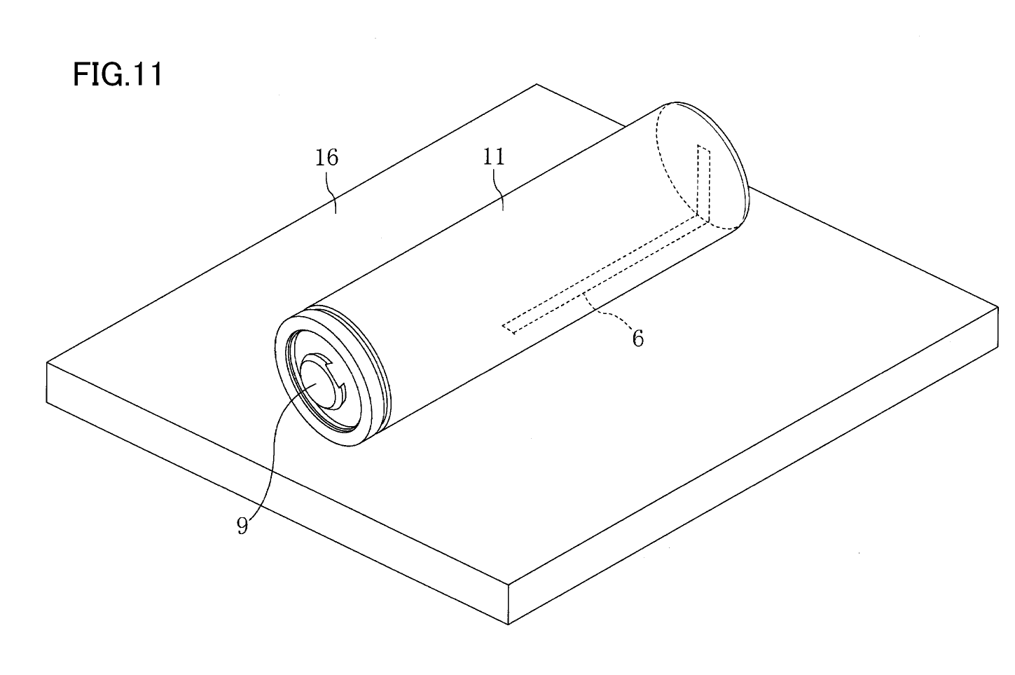

### BRIEF DESCRIPTION OF THE DRAWINGS

[FIG. 1] FIG. 1 is a cross-sectional view illustrating the structure of a battery of a first embodiment of the present invention.

[FIG. 2] FIGS. 2(a)-2(b) show the structure of a battery pack of a second embodiment of the present invention.

[FIG. 3] FIG. 3 shows the definition of a first end, a center portion, and a second end of a negative electrode internal lead.

[FIG. 4] FIG. 4 is a cross-sectional view illustrating the structure of another example of the battery pack of the second embodiment of the present invention.

[FIG. 5] FIG. 5 is a perspective view illustrating the structure of a battery including an indicator provided on an outer surface of a sealing plate.

[FIG. 6] FIG. 6 is a plan view illustrating a positional relationship between a sealing plate and a positive electrode internal lead, and between the sealing plate and a negative electrode internal lead.

[FIG. 7] FIGS. 7(a)-7(b) show the structure of a battery including an indicator provided on an outer side surface of a battery case.

[FIG. 8] FIGS. 8(a)-8(b) show the structure of a battery including an indicator provided on an outer side surface of a battery case.

[FIG. 9] FIGS. 9(a)-9(b) show the structure of a battery including an indicator provided on an outer side surface of a battery case.

[FIG. 10] FIG. 10 is a perspective view illustrating the structure of a battery including an indicator provided on an outer bottom surface of a battery case.

[FIG. 11] FIG. 11 shows how an external short circuit test is performed.

### DESCRIPTION OF EMBODIMENTS

How the present invention has been achieved by the inventors of the present invention will be described before description of embodiments.

It has been known that ensuring battery safety is difficult when an external short circuit occurs in one or more batteries contained in a pack case of a battery pack. To ensure the battery safety even when the external short circuit occurs in the battery, the inventors of the present invention have checked the inside of the battery in which the external short circuit occurs. Specifically, a cylindrical lithium ion secondary battery was used in which a positive electrode internal lead which is electrically connected to a positive electrode is connected to a sealing plate, and a negative electrode lead which is electrically connected to a negative electrode is connected to a battery case. The external short circuit was caused in the battery to check the inside of the battery.

As a result, the inventors of the present invention have found that the positive electrode internal lead and the negative electrode internal lead generate heat when the external short circuit occurred in the battery, and in particular, the negative electrode internal lead significantly generates heat. A cause of the heat generation presumed by the inventors of the present invention is described below.

The negative electrode internal lead has higher resistance than battery components except for the negative electrode internal lead. Specifically, in most lithium ion secondary batteries, the negative electrode internal lead is made of nickel, the negative electrode current collector is made of copper, and the positive electrode internal lead and the positive electrode current collector are made of aluminum. Nickel has a higher specific resistance than copper and aluminum. Accordingly, the negative electrode internal lead has higher resistance than the negative electrode current collector, the positive electrode internal lead, and the positive electrode current collector. Joule heat is proportional to a resistance value. Thus, when the external short circuit occurs in the lithium ion secondary battery, the largest amount of heat is generated by the negative electrode internal lead. Therefore, the negative electrode internal lead significantly generates heat.

In view of the above findings and studies on the findings, the inventors of the present invention have found that if the heat generated by the negative electrode internal lead is efficiently dissipated to the pack case, the possibility of the overheat of the battery which experienced the external short circuit can be reduced, thereby ensuring safety of the battery, and safety of the battery pack.

In the above description, the lithium ion secondary battery has been described in which the positive electrode internal lead is connected to the sealing plate, and the negative electrode internal lead is connected to the battery case. Contrary to this structure, as to a lithium ion secondary battery in which the positive electrode internal lead is connected to the battery case, and the negative electrode internal lead is connected to the sealing plate, the following was found.

When the external short circuit occurs in the battery, the positive electrode internal lead generates heat (from the foregoing consideration, the amount of heat generated by the positive electrode internal lead is assumed to be smaller than the amount of heat generated by the negative electrode internal lead). Therefore, if the heat generated by the positive electrode internal lead is efficiently dissipated to the pack case, the possibility of the overheat of the battery which experienced the external short circuit can be reduced, thereby ensuring safety of the battery, and safety of the battery pack.

Based on the foregoing findings, the inventors of the present invention have arranged part of an outer side surface of the battery case corresponding to the first internal lead in contact with an inner side surface of the pack case as shown in FIGS. 2(a)-2(b) described later. Thus, the first internal lead can be arranged near the pack case. Therefore, even when the external short circuit occurs in the battery, and the first internal lead generates heat, the heat generated by the first internal lead can be transferred to the battery case which is thermally conductive, thereby efficiently dissipating the heat to the pack case.

In particular, when the first internal lead is the negative electrode internal lead, the negative electrode internal lead significantly generates heat when the external short circuit occurs in the battery as described above. In this case, the present invention is advantageously applied.

As described above, the present invention has been achieved by arranging the first internal lead connected to the battery case near the inner side surface of the battery case than the second internal lead connected to the sealing plate, thereby efficiently dissipating the heat generated by the first internal lead to the pack case. Thus, the object of the invention has been achieved.

Embodiments of the present invention will be described below with reference to the drawings.

### First Embodiment

A battery of the first embodiment of the present invention will be described by way of an example of a cylindrical lithium ion secondary battery with reference to FIG. 1. FIG. 1 is a cross-sectional view illustrating the structure of the battery of the first embodiment of the present invention.

As shown in FIG. 1, an electrode group 4 is placed in a cylindrical battery case 11 having a closed bottom together with a nonaqueous electrolyte solution. An annular upper insulator 7 is arranged at an upper end of the electrode group 4, and an annular lower insulator 8 is arranged at a lower end of the electrode group 4. An opening end of the battery case 11 is crimped onto the periphery of a sealing plate 9 with a gasket 10 interposed therebetween to close the opening of the battery case 11.

The electrode group 4 includes a strip-shaped positive electrode 1 and a strip-shaped negative electrode 2 wound with a separator 3 as a strip-shaped porous insulating layer interposed therebetween.

The positive electrode 1 includes a positive electrode current collector, and a positive electrode active material layer formed on a surface of the positive electrode current collector to expose part of the surface of the positive electrode current collector. The part of the positive electrode current collector exposed from the positive electrode active material layer (hereinafter referred to as “an exposed part of the positive electrode current collector”) is provided in a center portion of the positive electrode 1. The “center portion of the positive electrode” is a portion between a first wound end and a last wound end of the positive electrode constituting the electrode group.

The negative electrode 2 includes a negative electrode current collector, and a negative electrode active material layer formed on a surface of the negative electrode current collector to expose part of the surface of the negative electrode current collector. The part of the negative electrode current collector exposed from the negative electrode active material layer (hereinafter referred to as “an exposed part of the negative electrode current collector”) is provided at the last wound end of the negative electrode 2.

The positive electrode 1 and the sealing plate 9 are electrically connected through a positive electrode internal lead 5. A first end of the positive electrode internal lead 5 is connected to the exposed part of the positive electrode current collector. A second end of the positive electrode internal lead 5 is connected to a lower plate 9c of the sealing plate 9. The sealing plate 9 functions as a positive electrode terminal.

The negative electrode 2 and the battery case 11 are electrically connected through a negative electrode internal lead 6. A first end of the negative electrode internal lead 6 is connected to the exposed part of the negative electrode current collector. A second end of the negative electrode internal lead 6 is connected to an inner bottom surface of the battery case 11. The battery case 11 functions as a negative electrode terminal.

The sealing plate 9 includes a positive electrode cap 9a having an air outlet, a valve element 9b which breaks when an internal pressure of the battery case 11 exceeds a predetermined value, a current breaker such as a positive temperature coefficient (PTC) device etc., and a lower plate 9c to which the positive electrode internal lead 5 is connected. When an amount of gas generated in the battery case 11 increases, and the internal pressure of the battery case 11 exceeds the predetermined value due to overcharge of the battery etc., the valve element 9b breaks, and the gas is discharged out of the battery through the air outlet in the positive electrode cap 9a.

The battery includes an indicator (not shown) for indicating the position of the negative electrode internal lead 6 contained in the battery case 11. For example, the indicator is provided on an outer surface of the sealing plate 9 (see FIG. 5 described later), an outer side surface of the battery case (see FIGS. 7(a), 7(b)-FIGS. 9(a), 9(b) described later), or an outer bottom surface of the battery case (see FIG. 10 described later). The position of the negative electrode internal lead 6 contained in the battery case 11 can be found based on the indicator.

According to the present embodiment, the position of the negative electrode internal lead 6 contained in the battery case 11 can be found based on the indicator. Thus, in placing the battery of the present embodiment in a pack case of a battery pack, the negative electrode internal lead 6 can be arranged near the pack case based on the position of the negative electrode internal lead 6 indicated by the indicator. Therefore, even when an external short circuit occurs in the battery contained in the pack case, and the negative electrode internal lead 6 significantly generates heat, the heat generated by the negative electrode internal lead 6 can be transferred to the battery case 11 which is thermally conductive, thereby efficiently dissipating the heat to the pack case. In particular, when the pack case has a heat dissipating property, the heat can be dissipated more efficiently to the pack case.

Thus, in the battery pack containing the battery of the present invention in the pack case, the possibility of the overheat of the battery which experienced the external short circuit can be reduced, thereby ensuring safety of the battery, and safety of the battery pack.

With the negative electrode internal lead 6 arranged near the pack case, the heat generated in the battery which experienced the external short circuit (in particular, the heat generated by the negative electrode internal lead 6) can efficiently be dissipated to the pack case as described above. Specifically, the heat generated in the battery which experienced the external short circuit can efficiently be dissipated outside the battery. Different from the technology taught by Patent Document 1, there is no need to provide an additional special component (i.e., a pair of heat dissipating plates), and the weight of the battery pack would not increase.

In the present embodiment, the electrode group 4 including the positive electrode 1 and the negative electrode 2 wound with the separator 3 interposed therebetween has been described as an example. However, the present invention is not limited to this example. For example, the present invention can be applied to a stacked electrode group including the positive electrode and the negative electrode stacked with the separator interposed therebetween.

In the present embodiment, the separator is used as the porous insulating layer. However, a non-fluidized polymeric electrolyte layer prepared by adding a polymeric material to a nonaqueous electrolyte solution may be used in place of the separator.

### Second Embodiment

A battery pack of a second embodiment of the present invention will be described with reference to FIGS. 2(a)-2(b). FIGS. 2(a)-2(b) show the structure of the battery pack of the second embodiment of the present invention. Specifically, FIG. 2(a) is a cross-sectional view, and FIG. 2(b) is a perspective cross-sectional view.

The battery pack of the present embodiment contains the batteries 12 of the first embodiment in a pack case 13.

As shown in FIGS. 2(a)-2(b), the batteries 12 are placed in the pack case 13 based on the position of the negative electrode internal lead 6 indicated by the indicator. Specifically, each of the batteries 12 is placed in the pack case 13 in such a manner that part of an outer side surface of the battery case 11 corresponding to the negative electrode internal lead 6, i.e., part of the battery case 11 corresponding to a first end (see reference character 6a in FIG. 3) of the negative electrode internal lead 6, contacts an inner side surface of the pack case 13.

The first end, a center portion, and the second end of the negative electrode internal lead will be described with reference to FIG. 3. FIG. 3 shows the definition of the first end, the center portion, and the second end of the negative electrode internal lead. The negative electrode internal lead 6 extends from an exposed part 2a of the negative electrode current collector in the direction opposite to the negative electrode current collector, is bent at a boundary between the inner side surface and the inner bottom surface of the battery case 11, and extends toward the center of the inner bottom surface of the battery case 11. The first end 6a of the negative electrode internal lead 6 is part of the negative electrode internal lead 6 in contact with the exposed part 2a of the negative electrode current collector. The first end 6a is partially welded to the exposed part 2a of the negative electrode current collector. The second end 6b is part of the negative electrode internal lead 6 in contact with the inner bottom surface of the battery case 11. The second end 6b is partially welded to the battery case 11. The center portion 6c is part of the negative electrode internal lead 6 which is sandwiched between the first end 6a and the second end 6b, and is not in contact with the exposed part 2a of the negative electrode current collector, and the inner bottom surface of the battery case 11, i.e., part of the negative electrode internal lead 6 surrounded by a nonaqueous electrolyte solution.

The pack case 13 is preferably made of a heat dissipating member. Examples of the heat dissipating member include, for example, metals and resins having higher thermal conductivity than air.

According to the present embodiment, the position of the negative electrode internal lead 6 contained in the battery case 11 can be found based on the indicator. Thus, based on the position of the negative electrode internal lead 6 indicated by the indicator, each of the batteries 12 can be placed in the pack case 13 in such a manner that the part of the outer side surface of the battery case 11 corresponding to the negative electrode internal lead 6 contacts the inner side surface of the pack case 13, thereby arranging the negative electrode internal leads 6 near the pack case 13. Therefore, even when the external short circuit occurs in the battery 12, and the negative electrode internal lead 6 generates heat, the heat generated by the negative electrode internal lead 6 can be transferred to the battery case 11 which is thermally conductive, thereby efficiently dissipating the heat to the pack case 13. In particular, when the pack case 13 is made of a heat dissipating member (i.e., when the pack case 13 has a heat dissipating property), the heat can be dissipated more efficiently to the pack case 13.

Thus, in the battery pack of the present embodiment, the possibility of the overheat of the battery which experienced the external short circuit can be reduced, thereby ensuring safety of the battery, and safety of the battery pack.

With the negative electrode internal lead 6 arranged near the pack case 13, the heat generated in the battery which experienced the external short circuit (in particular, the heat generated by the negative electrode internal lead 6) can efficiently be dissipated to the pack case 13 as described above. Specifically, the heat generated in the battery due to the external short circuit can efficiently be dissipated outside the battery. Different from the technology taught by Patent Document 1, there is no need to provide an additional special component (i.e., a pair of heat dissipating plates), and the weight of the battery pack would not increase.

In the present embodiment, the battery pack in which part of the outer side surface of the battery case 11 corresponding to the negative electrode internal lead 6 contacts the inner side surface of the pack case 13 as shown in FIG. 2(a)-2(b) has been described as an example of the battery pack which allows efficient dissipation of the heat generated by the negative electrode internal lead 6 to the pack case. However, the present invention is not limited to this example.

For example, a heat dissipator may be provided between the pack case and the battery, and the part of the outer side surface of the battery case corresponding to the negative electrode internal lead may be brought into contact with the heat dissipator. This structure will be described with reference to FIG. 4. FIG. 4 is a cross-sectional view illustrating the structure of another example of the battery pack of the second embodiment.

As shown in FIG. 4, a plate-like heat dissipator 14 made of a heat dissipating member is provided to meet the part of the outer side surface of the battery case 11 corresponding to the negative electrode internal lead 6 of each of the batteries. The heat dissipator 14 is arranged with one of the surfaces thereof in contact with the inner side surface of the pack case 13. Each of the batteries 12 is arranged in such a manner that the part of the outer side surface of the battery case 11 corresponding to the negative electrode internal lead 6 contacts the other surface of the heat dissipator 14 (a surface of the heat dissipator 14 opposite the surface thereof in contact with the inner side surface of the pack case 13).

With this configuration, even when the external short circuit occurs in the battery 12, and the negative electrode internal lead 6 significantly generates heat, the heat generated by the negative electrode internal lead 6 is transferred to the battery case 11, and is efficiently dissipated to the heat dissipator 14. Thus, the heat efficiently dissipated to the heat dissipator 14 can efficiently be dissipated to the pack case 13.

Examples of the battery including the indicator will be described below. A first example of the battery includes the indicator on an outer surface of the sealing plate, a second example of the battery includes the indicator on an outer side surface of the battery case, and a third example of the battery includes the indicator on an outer bottom surface of the battery case.

### <Battery Including Indicator on Outer Surface of Sealing Plate>

A battery including the indicator on the outer surface of the sealing plate will be described with reference to FIG. 5. FIG. 5 is a perspective view illustrating the structure of the battery including the indicator on the outer surface of the sealing plate.

As shown in FIG. 5, an indicator 15A is provided on part of the outer surface of the sealing plate 9 corresponding to the negative electrode internal lead 6. As shown in FIG. 5, the indicator 15A is arranged to correspond to the second end 6b of the negative electrode internal lead 6. The indicator 15A may be, for example, a print which is ink-jet printed in the shape of a line on the outer surface of the sealing plate 9.

A method for fabricating the battery including the indicator on the outer surface of the sealing plate will be described below.

First, a positive electrode and a negative electrode are prepared.

Then, a first end of the positive electrode internal lead is connected to an exposed part of the positive electrode current collector, and a first end of the negative electrode internal lead is connected to an exposed part of the negative electrode current collector. The positive and negative electrodes are wound with a separator interposed therebetween to constitute an electrode group.

An upper insulator is arranged at an upper end of the electrode group, and a lower insulator is arranged at a lower end of the electrode group. The electrode group is then placed in a battery case, a second end of the positive electrode internal lead is connected to a lower plate of the sealing plate, and a second end of the negative electrode internal lead is connected to an inner bottom surface of the battery case.

Based on the position of the positive electrode internal lead viewed from an opening of the battery case, the position of the negative electrode internal lead is determined. Then, an indicator for indicating the position of the negative electrode internal lead is provided on the outer surface of the sealing plate.

The positive electrode, the negative electrode, and the separator have the predetermined lengths, widths, and thicknesses determined based on the battery design, respectively. The exposed part of the positive electrode current collector of the positive electrode to which the positive electrode internal lead is connected is provided at a predetermined part of the positive electrode based on the battery design (e.g., a center portion of the positive electrode). The exposed part of the negative electrode current collector of the negative electrode to which the negative electrode internal lead is connected is provided at a predetermined part of the negative electrode based on the battery design (e.g., a last wound end of the negative electrode). The positive electrode internal lead and the negative electrode internal lead have the predetermined lengths, width, and thicknesses determined based on the battery design, respectively. Based on the position of the positive electrode internal lead viewed from the opening of the battery case, the position of the negative electrode internal lead connected to the inner bottom surface of the battery case can be determined. Specifically, as shown in FIG. 6, when the positive electrode internal lead 5 viewed from the opening of the battery case is at position P5 which passes the center of the sealing plate 9, the negative electrode internal lead 6 is at position P16A which is moved clockwise relative to the center of the sealing plate 9 by an angle α. The angle α is determined in advance based on the battery design.

A nonaqueous electrolyte solution is then injected in the battery case. Then, the opening of the battery case is crimped onto the periphery of the sealing plate with a gasket interposed therebetween to fabricate the battery.

In this way, the position of the negative electrode internal lead 6 contained in the battery case 11 can be found based on the indicator 15A provided on the outer surface of the sealing plate 9.

Even after the batteries are contained in the pack case in the fabrication of the battery pack, the outer surface of the sealing plate 9 can be checked from an opening of the pack case. Thus, the position of the negative electrode internal lead 6 can be found based on the indicator 15A provided on the outer surface of the sealing plate 9 (after the opening of the pack case is closed, the position of the negative electrode internal lead 6 is no longer determined).

In the above description, the print which is ink-jet printed in the shape of a line was described as an example of the indicator 15A. However, the present invention is not limited to this example. For example, the indicator may be an ink-jet print of letters or characters, or an ink-jet print in the shape of a mesh or dots.

In the above description, the print which is ink-jet printed on part of the outer surface of the sealing plate 9 corresponding to the negative electrode internal lead 6 has been described as an example of the indicator 15A. However, the present invention is not limited to this example. For example, the indicator 15A may be a recessed portion formed in the part of the outer surface of the sealing plate corresponding to the negative electrode internal lead.

<Battery Including Indicator on Outer Side surface of Battery Case>

A battery including the indicator on the outer side surface of the battery case will be described below. As examples of the indicator, a print, a flat portion, and a raised portion will be described.

### —First Example of Battery—

A battery including the indicator (e.g., a print) on the outer side surface of the battery case will be described with reference to FIGS. 7(a)-7(b). FIGS. 7(a)-7(b) show the structure of the battery including the indicator on the outer side surface of the battery case. Specifically, FIG. 7(a) is a perspective view, and FIG. 7(b) is a perspective view, partially cut away.

As shown in FIGS. 7(a)-7(b), a print 15B as the indicator is provided on part of the outer side surface of the battery case 11 corresponding to the negative electrode internal lead 6. As shown in FIG. 7(b), the print 15B is arranged to correspond to the first end 6a of the negative electrode internal lead 6. The print 15B may be ink-jet printed on the outer side surface of the battery case 11, for example.

The negative electrode internal lead 6 has a thickness of 0.05 mm-0.2 mm, and a width of 2 mm-5 mm, for example. The print 15B has a width of 0.5 mm-5 mm, for example.

With this configuration, the position of the negative electrode internal lead 6 contained in the battery case 11 can be found based on the print 15B provided on the outer side surface of the battery case 11.

### —Second Example of Battery—

A battery including the indicator (e.g., a flat portion) on the outer side surface of the battery case will be described with reference to FIGS. 8(a)-8(b). FIGS. 8(a)-8(b) show the structure of the battery including the indicator on the outer side surface of the battery case. Specifically, FIG. 8(a) is a perspective view, and FIG. 8(b) is a plan view observed from an outer bottom surface of the battery.

As shown in FIGS. 8(a)-8(b), a flat portion 15C as the indicator is provided on part of the outer side surface of the battery case 11 corresponding to the negative electrode internal lead 6 (i.e., part of the battery case 11 corresponding to the first end (see reference character 6a in FIG. 3) of the negative electrode internal lead 6.

With this configuration, the position of the negative electrode internal lead 6 contained in the battery case 11 can be found based on the flat portion 15C provided on the outer side surface of the battery case 11.

In addition, firstly, when part of the pack case to be in contact with the flat portion 15C is made flat, the whole flat portion 15C of the battery case 11 can be brought into contact with the pack case. Secondly, for example, when a heat dissipator (see reference character 14 in FIG. 4) is provided on a part of the outer side surface of the battery case 11 corresponding to the negative electrode internal lead 6, a part of the heat dissipator in contact with the flat portion 15C is made flat. This can bring the whole flat portion 15C of the battery case 11 into contact with the heat dissipator.

### —Third Example of Battery—

A battery including the indicator (e.g., a raised portion) on the outer side surface of the battery case will be described with reference to FIGS. 9(a)-9(b). FIGS. 9(a)-9(b) show the structure of the battery including the indicator on the outer side surface of the battery case. Specifically, FIG. 9(a) is a perspective view, and FIG. 9(b) is a plan view observed from an outer bottom surface of the battery.

As shown in FIGS. 9(a)-9(b), a raised portion 15D as the indicator is provided on part of the outer side surface of the battery case 11 corresponding to the negative electrode internal lead 6 (i.e., part of the battery case 11 corresponding to the first end (see reference character 6a in FIG. 3) of the negative electrode internal lead 6.

With this configuration, the position of the negative electrode internal lead 6 contained in the battery case 11 can be found based on the raised portion 15D provided on the outer side surface of the battery case 11.

In addition, firstly, when the pack case is provided with a recessed portion to be fitted with the raised portion 15D of the battery case 11, the battery can be arranged in the pack case in such a manner that the raised portion 15D of the battery case 11 is fitted in the recessed portion of the pack case. Secondly, when a heat dissipator (see reference character 14 in FIG. 4) is provided on part of the outer side surface of the battery case 11 corresponding to the negative electrode internal lead 6, a recessed portion may be provided in the heat dissipator to be fitted with the raised portion 15D of the battery case 11. Thus, the battery can be arranged with the raised portion 15D of the battery case 11 fitted in the recessed portion of the heat dissipator.

A method for fabricating the battery including the indicator on the outer side surface of the battery case will be described below.

### —First Example of Fabrication Method—

First, a positive electrode and a negative electrode are prepared.

A battery case provided with an indicator on an outer side surface thereof is prepared.

A first end of a positive electrode internal lead is connected to an exposed part of a positive electrode current collector, and a first end of a negative electrode internal lead is connected to an exposed part of a negative electrode current collector. Then, the positive and negative electrodes are wound with a separator interposed therebetween to constitute an electrode group.

An upper insulator is arranged at an upper end of the electrode group, and a lower insulator is arranged at a lower end of the electrode group. The electrode group is then placed in a battery case, a second end of the positive electrode internal lead is connected to a lower plate of a sealing plate, and a second end of the negative electrode internal lead is connected to an inner bottom surface of the battery case. The electrode group is placed in the battery case in such a manner that the first end (see reference character 6a in FIG. 3) of the negative electrode internal lead corresponds to the indicator provided on the outer side surface of the battery case.

A nonaqueous electrolyte solution is injected in the battery case. Then, an opening of the battery case is crimped onto a periphery of the sealing plate with a gasket interposed therebetween to fabricate a battery.

### —Second Example of Fabrication Method—

First, a positive electrode and a negative electrode are prepared.

Then, a first end of a positive electrode internal lead is connected to an exposed part of a positive electrode current collector, and a first end of a negative electrode internal lead is connected to an exposed part of a negative electrode current collector. The positive and negative electrodes are wound with a separator interposed therebetween to constitute an electrode group.

An upper insulator is arranged at an upper end of the electrode group, and a lower insulator is arranged at a lower end of the electrode group. The electrode group is then placed in a battery case, a second end of the positive electrode internal lead is connected to a lower plate of a sealing plate, and a second end of the negative electrode internal lead is connected to an inner bottom surface of the battery case.

An indicator is provided on part of an outer side surface of the battery case corresponding to the first end (see reference character 6a in FIG. 3) of the negative electrode internal lead.

Then, a nonaqueous electrolyte solution is injected in the battery case. An opening of the battery case is crimped onto a periphery of the sealing plate with a gasket interposed therebetween to fabricate a battery.

### <Battery Including Indicator on Outer Bottom Surface of Battery Case>

A battery including an indicator on an outer bottom surface of a battery case will be described with reference to FIG. 10. FIG. 10 shows the structure of the battery including the indicator on the outer bottom surface of the battery case.

As shown in FIG. 10, an indicator 15E is provided on part of the outer bottom surface of the battery case 11 corresponding to the negative electrode internal lead 6 (i.e., part of the battery case 11 corresponding to a second end (see reference character 6b in FIG. 3) of the negative electrode internal lead 6). The indicator 15E may be, for example, a weld mark which is left on the outer bottom surface of the battery case 11 when the negative electrode internal lead is connected to the inner bottom surface of the battery case.

A method for fabricating the battery including the indicator (e.g., a weld mark) on the outer bottom surface of the battery case will be described below.

First, a positive electrode and a negative electrode are prepared.

Then, a first end of a positive electrode internal lead is connected to an exposed part of a positive electrode current collector, and a first end of a negative electrode internal lead is connected to an exposed part of a negative electrode current collector. The positive and negative electrodes are wound with a separator interposed therebetween to constitute an electrode group.

An upper insulator is arranged at an upper end of the electrode group, and a lower insulator is arranged at a lower end of the electrode group. The electrode group is then placed in a battery case, a second end of the positive electrode internal lead is connected to a lower plate of a sealing plate, and a second end of the negative electrode internal lead is arranged on an inner bottom surface of the battery case.

Then, a laser beam is applied to the outer bottom surface of the battery case by laser welding, for example, to connect the second end of the negative electrode internal lead arranged on the inner bottom surface of the battery case to the inner bottom surface of the battery case. As a result, a weld mark is left on the outer bottom surface of the battery case. Thus, the weld mark is provided on the outer bottom surface of the battery case as the indicator.

A nonaqueous electrolyte solution is then injected in the battery case. Then, an opening of the battery case is crimped onto a periphery of the sealing plate with a gasket interposed therebetween to constitute a battery.

With this configuration, the position of the negative electrode internal lead 6 contained in the battery case 11 can be found based on the indicator 15E provided on the outer bottom surface of the battery case 11.

Further, the weld mark which is left on the outer bottom surface of the battery case 11 when the negative electrode internal lead is connected to the inner bottom surface of the battery case can be used as the indicator 15E. Therefore, an additional process of forming the indicator is no longer necessary.

In the second embodiment, the battery pack containing the batteries 12 each having the indicator (i.e., the batteries of the first embodiment) in the pack case 13 has been described as an example. However, the invention is not limited to this example. Specifically, the indicator provided on each battery is required in placing the batteries in the pack case in the fabrication of the battery pack. However, the indicator is no longer required after the battery pack has been fabricated. Therefore, the indicator may be lost after the batteries are placed in the pack case. From this point of view, the battery may be provided with a temporary indicator instead of a permanent indicator. The “permanent indicator” is an indicator which remains after the battery pack has been fabricated. The “temporary indicator” remains while the batteries are placed in the pack case in the fabrication of the battery pack, but disappears after the battery pack has been fabricated.

Materials of battery components will be described below.

### —Positive Electrode—

A positive electrode includes a positive electrode current collector, and a positive electrode active material layer formed on the positive electrode current collector.

Examples of the positive electrode current collector include, for example, metal foil such as aluminum foil, and a thin film made of carbon, or a conductive resin.

The positive electrode active material layer contains, for example, a positive electrode active material, a conductive agent, and a binder.

Examples of the positive electrode active material include, for example, lithium-containing composite oxide such as LiCoO₂, LiNiO₂, and Li₂MnO₄, a mixture of two or more of them, or a composite of two or more of them.

Examples of the conductive agent include, for example, graphites such as natural graphite, artificial graphite, etc., and carbon blacks such as acetylene black, Ketchen black, furnace black, lamp black, thermal black, etc.

Examples of the binder include, for example, polyvinylidene fluoride (PVdF), polytetrafluoroethylene, polyethylene, polypropylene, aramid resin, polyamide, and polyimide.

The positive electrode internal lead may be made of, for example, aluminum.

### —Negative Electrode—

A negative electrode includes a negative electrode current collector, and a negative electrode active material layer formed on the negative electrode current collector.

Examples of the negative electrode current collector, for example, metal foil such as copper foil, stainless steel foil, nickel foil, titanium foil, etc., and a thin film made of carbon or a conductive resin.

The negative electrode active material layer contains, for example, a negative electrode active material, a conductive agent, and a binder. The negative electrode active material layer may be a lithium metal plate, or a lithium alloy plate.

The negative electrode active material may be, for example, a carbon material such as graphite, and a material such as silicon or tin capable of reversibly inserting and extracting lithium ions.

The conductive agent may be the same conductive agent contained in the positive electrode active material layer.

The binder may be the same binder contained in the positive electrode active material layer.

The negative electrode internal lead may be made of, for example, nickel.

### —Separator—

A separator may be made of, for example, polyethylene, polypropylene, a mixture of polyethylene and polypropylene, or a copolymer of ethylene and propylene.

### —Nonaqueous Electrolyte Solution—

A nonaqueous electrolyte solution contains, for example, an organic solvent, and lithium salt dissolved in the organic solvent.

Examples of the lithium salt include, for example, LiPF₆, LiBF₄, LiClO₄, LiAlCl₄, LiSbF₆, LiSCN, LiCF₃SO₃, LiN(CF₃CO₂), and LiN(CF₃SO₂)₂.

Examples of the organic solvent include, for example, ethylene carbonate, propylene carbonate, butylene carbonate, vinylene carbonate, dimethyl carbonate, diethyl carbonate, and ethyl methyl carbonate.

### —Battery Case—

A battery case may be made of, for example, iron, nickel, copper, or aluminum.

### —Pack Case—

A pack case may be made of, for example, polycarbonate.

When the pack case is made of a heat dissipating member, the heat dissipating member may be made of metal or resin having a higher thermal conductivity than air. The metal may be, for example, aluminum. The resin may be, for example, resin containing carbon fibers. The pack case may also be made of a high specific heat material such as ceramic, a material which absorbs latent heat as it is molten or sublimated by heat, or a material capable of absorbing heat as it decomposes, such as magnesium hydroxide, magnesium carbonate, or aluminum hydroxide.

### —Heat Dissipator—

When a heat dissipator made of a heat dissipating member is provided on part of an outer side surface of the battery case corresponding to the negative electrode internal lead, the heat dissipating member may be made of metal or resin having a higher thermal conductivity than air. The metal may be, for example, aluminum. The resin may be, for example, a resin containing carbon fibers. The heat dissipator may also be made of a high specific heat material, such as ceramic, a material which absorbs latent heat as it is molten, evaporated, or sublimated by heat, such as solder, brazing filler metal, low-melting glass, water, etc., or a material capable of absorbing heat as it decomposes, such as magnesium hydroxide, magnesium carbonate, or aluminum hydroxide.

### EXAMPLES

Examples of the invention will be described below. The examples are described only for the illustrative purpose, and the present invention is not limited to the examples.

### Example 1

A method for fabricating a battery of Example 1 will be described with reference to FIG. 1.

### (1) Fabrication of Positive Electrode

A hundred parts by weight (pbw) of lithium cobaltate (LiCoO₂) as a positive electrode active material having an average particle diameter of 10 μm, 8 pbw of PVdF as a binder, and 3 pbw of acetylene black as a conductive agent, and an appropriate amount of N-methyl-2-pyrrolidone (NMP) were mixed to obtain positive electrode material mixture paste.

The positive electrode material mixture paste was applied to each surface of a strip-shaped positive electrode current collector made of aluminum foil of 600 mm in length, 54 mm in width, and 20 μm in thickness, while the paste was not applied to a center portion of the positive electrode current collector (i.e., an exposed part of the positive electrode current collector to which a positive electrode internal lead is connected). Then, the positive electrode material mixture paste was dried to form a positive electrode active material layer. Thus, a stack of the positive electrode current collector, and the positive electrode active material layers formed on both surfaces of the positive electrode current collector was obtained. The stack was rolled to control the thickness of the positive electrode active material layer to 70 μm. Thus, a strip-shaped positive electrode 1 having an exposed portion in the center portion of the positive electrode current collector was formed.

Then, a strip-shaped aluminum positive electrode internal lead 5 of 50 mm in length, 3 mm in width, and 0.1 mm in thickness was prepared, and a first end of the positive electrode internal lead 5 was connected to the exposed part of the positive electrode current collector by ultrasonic welding.

### (2) Fabrication of Negative Electrode

A hundred pbw of artificial graphite as a negative electrode active material having an average particle diameter of 20 μm, 1 pbw of styrene butadiene rubber as a binder, 1 pbw of carboxymethyl cellulose as a thickening agent, and an approximate amount of water were mixed to prepare negative electrode active material paste.

The negative electrode active material paste was applied to each surface of a negative electrode current collector made of copper foil of 630 mm in length, 56 mm in width, and 10 μm in thickness, while the paste was not applied to a last wound end of the negative electrode current collector (i.e., an exposed part of the negative electrode current collector to which a negative electrode internal lead is connected). Then, the negative electrode active material paste was dried to form a negative electrode active material layer. Thus, a stack of the negative electrode current collector, and the negative electrode active material layers formed on both surfaces of the negative electrode current collector was obtained. The stack was rolled to control the thickness of the negative electrode active material layer to 65 μm. Thus, a strip-shaped negative electrode 2 having an exposed part of the negative electrode current collector at the last wound end thereof was formed.

A strip-shaped nickel negative electrode internal lead 6 of 50 mm in length, 3 mm in width, and 0.1 mm in thickness was prepared, and a first end of the negative electrode internal lead 6 was connected to the exposed part of the negative electrode current collector by ultrasonic welding.

### (3) Preparation of Nonaqueous Electrolyte Solution

To a solvent mixture of ethylene carbonate and ethyl methyl carbonate in the volume ratio of 1:1, LiPF₆ was dissolved in a concentration of 1.0 mol/L to prepare a nonaqueous electrolyte solution.

### (4) Fabrication of Battery

A positive electrode 1 and a negative electrode 2 were wound with a separator 3 manufactured by Asahi Kasei Corporation, i.e., a 20 μm thick polyethylene microporous film, interposed therebetween to constitute an electrode group 4. The positive electrode 1 and the negative electrode 2 were wound in such a manner that an exposed part of a positive electrode current collector to which a positive electrode internal lead 5 is connected is positioned at the center portion, and an exposed part of a negative electrode current collector to which a negative electrode internal lead 6 is connected is positioned at a last wound end after the winding. Further, the positive electrode 1 and the negative electrode 2 were wound in such a manner that the positive electrode internal lead 5 protrudes upward from an upper end of the electrode group 4, and the negative electrode internal lead 6 protrudes downward from lower end of the electrode group 4 after the winding.

A polypropylene upper insulator 7 was arranged at an upper end of the electrode group 4, and a polypropylene lower insulator 8 was arranged at a lower end of the electrode group 4. The electrode group 4 was then placed in a cylindrical iron battery case 11 having a closed bottom. A second end of the positive electrode internal lead 5 is connected to a lower plate 9c of a sealing plate 9 by laser welding, and a second end of the negative electrode internal lead 6 is connected to an inner bottom surface of the battery case 11 by resistance welding.

A line-shaped print (see reference character 15B in FIGS. 7(a) and 7(b)) was provided as an indicator on part of an outer side surface of the battery case 11 corresponding to the negative electrode internal lead 6. The line-shaped print was provided on the outer side surface of the battery case 11 in such a manner that a center axis in the longitudinal direction of the line-shaped print corresponds to a center axis in the longitudinal direction of the negative electrode internal lead 6.

A nonaqueous electrolyte solution was injected in the battery case 11. Then, a constricted part was formed in the battery case 11 at a distance of 5 mm below an opening end of the battery case 11. A sealing plate 9 was arranged on the constricted part of the battery case 11 with an annular gasket 10 interposed therebetween. Then, the opening of the battery case 11 was crimped to the periphery of the sealing plate 9 with the gasket 10 interposed therebetween to seal the opening of the battery case 11. Thus, a cylindrical lithium ion secondary battery having a diameter of 18 mm, a height of 65 mm, and a design capacity of 2600 mAh was fabricated. The fabricated battery was referred to as a battery of Example 1.

### Comparative Example 1

A battery was fabricated in the same manner as described in Example 1 except that the indicator was not provided on the outer side surface of the battery case 11. The fabricated battery was referred to as a battery of Comparative Example 1.

### [External Short Circuit Test]

Ten batteries of Example 1 were prepared. The ten batteries of Example 1 were referred to as Batteries 1-10, respectively. Ten batteries of Comparative Example 1 were also prepared. The ten batteries of Comparative Example 1 were referred to as Batteries 11-20, respectively.

Batteries 1-10 of Example 1, and Batteries 11-20 of Comparative Example 1 were charged at a constant current of 1500 A until a battery voltage reached 4.25 V in an environment of 25° C.

Then, as shown in FIG. 11, each of Batteries 1-10 of Example 1 was placed on a flat heat dissipating plate 16 which was made of SUS304 (stainless steel containing chromium (Cr) and nickel (Ni)), and had a length of 100 mm, a width of 100 mm, and a thickness of 10 mm. Each of Batteries 1-10 was placed on the heat dissipating plate 16 in such a manner that a longitudinal center axis of the print provided on the outer side surface of the battery case 11 contacts the heat dissipating plate 16.

Each of Batteries 11-20 of Comparative Example 1 was placed on the heat dissipating plate 16.

Batteries 1-10 of Example 1 placed on the heat dissipating plates 16, and Batteries 11-20 of Comparative Example 1 placed on the heat dissipating plates 16 were left in an environment of 60° C. for 1 hour.

Then, in each of Batteries 1-10 of Example 1 placed on the heat dissipating plates 16, and each of Batteries 11-20 of Comparative Example 1 placed on the heat dissipating plates 16, an external short circuit was caused between the positive electrode and the negative electrode for 10 seconds using a test circuit having a resistance of 0.005Ω in an environment of 60° C. At that time, temperature of the surface of each of Batteries 1-10 of Example 1, and Batteries 11-20 of Comparative Example 1 was measured (hereinafter referred to as “battery temperature”). Table 1 shows the results of the external short circuit test. Table 1 shows battery temperatures of Batteries 1-10 of Example 1, and battery temperatures of Batteries 11-20 of Comparative Example 1.

TABLE 1

| Example 1 | | Comparative Example 1 | |
|---|---|---|---|
| Battery 1 | 68° C. | Battery 11 | 88° C. |
| Battery 2 | 61° C. | Battery 12 | 66° C. |
| Battery 3 | 64° C. | Battery 13 | 94° C. |
| Battery 4 | 64° C. | Battery 14 | 99° C. |
| Battery 5 | 65° C. | Battery 15 | 81° C. |
| Battery 6 | 61° C. | Battery 16 | 90° C. |
| Battery 7 | 66° C. | Battery 17 | 88° C. |
| Battery 8 | 66° C. | Battery 18 | 83° C. |
| Battery 9 | 67° C. | Battery 19 | 78° C. |
| Battery 10 | 62° C. | Battery 20 | 96° C. |

In the external short circuit test, batteries having a temperature not higher than 80° C. were considered as highly safe batteries.

As shown in Table 1, none of Batteries 1-10 of Example 1 showed the battery temperature higher than 80° C. On the other hand, eight of Batteries 11-20 of Comparative Example 1 showed the battery temperature higher than 80° C.

The results of the external short circuit test indicates that Batteries 1-10 of Example 1 were highly safe batteries because heat generated by the negative electrode internal lead when the external short circuit occurred in the battery was efficiently dissipated to the heat dissipating plate 16.

In the first and second embodiments, and Example 1, batteries in which the positive electrode internal lead is connected to the sealing plate, and the negative electrode internal lead is connected to the inner bottom surface of the battery case have been described as examples. However, the present invention is not limited to these examples.

For example, the positive electrode internal lead may be connected to the inner bottom surface of the battery case, and the negative electrode internal lead may be connected to the sealing plate. In this case, heat generated by the positive electrode internal lead when the external short circuit occurred in the battery can efficiently be dissipated to the pack case.

### INDUSTRIAL APPLICABILITY

A battery pack containing the batteries of the present invention, and the battery pack of the present invention are highly safe, and therefore, can suitably be applied to a power source of mobile electronic devices such as personal computers, cellular phones, mobile devices, personal digital assistants (PDA), hand-held game machines, video cameras, etc. The battery pack containing the batteries of the present invention, and the battery pack of the present invention are also applicable to a power source for assisting an electric motor of hybrid electric vehicles, fuel cell electric vehicles, etc., to a drive source for driving electric power tools, cleaners, robots, etc., and to a drive source for plug-in hybrid electric vehicles (PHEV).

### DESCRIPTION OF REFERENCE CHARACTERS

1 Positive electrode
2 Negative electrode
2a Exposed part of negative electrode current collector
3 Separator
4 Electrode group
5 Positive electrode internal lead
6 Negative electrode internal lead
6a First end
6b Second end
6c Center portion
7 Upper insulator
8 Lower insulator
9 Sealing plate
9a Positive electrode cap
9b Valve element
9c Lower plate
10 Gasket
11 Battery case
12 Battery
13 Pack case
14 Heat dissipator
15A Indicator (print)
15B Print
15C Flat portion
15D Raised portion
15E Indicator (weld mark)
16 Heat dissipating plate

1. A battery contained in a pack case of a battery pack, comprising:
an electrode group which includes a positive electrode and a negative electrode wound or stacked with a porous insulating layer interposed therebetween, and is placed in a battery case together with an electrolyte solution, an opening of the battery case being sealed by a sealing plate;
a first internal lead which is electrically connected to one of the positive electrode and the negative electrode, and is connected to an inner bottom surface of the battery case; and
a second internal lead which is electrically connected to the other one of the positive electrode and the negative electrode, and is connected to the sealing plate, wherein
the first internal lead is arranged near an inner side surface of the battery case, and
an indicator for indicating the position of the first internal lead contained in the battery case is provided.

2. The battery of claim 1, wherein
the first internal lead is a negative electrode internal lead which is electrically connected to the negative electrode, and
the second internal lead is a positive electrode internal lead which is electrically connected to the positive electrode.

3. The battery of claim 1, wherein
the electrode group includes the positive electrode and the negative electrode wound with the porous insulating layer interposed therebetween,
one of the electrodes to which the first internal lead is electrically connected includes a current collector, and an active material layer which is formed on a surface of the current collector to expose part of the surface of the current collector,
the first internal lead is connected to the part of the current collector exposed from the active material layer formed on the surface of the current collector, and
the exposed part of the current collector is positioned at a last wound end of the electrode to which the first internal lead is electrically connected.

4. The battery of claim 1, wherein
the indicator is provided on an outer surface of the sealing plate.

5. The battery of claim 4, wherein
the indicator is a print which is printed on part of the outer surface of the sealing plate corresponding to the first internal lead.

6. The battery of claim 1, wherein
the indicator is provided on an outer side surface of the battery case.

7. The battery of claim 6, wherein
the indicator is a print which is printed on part of the outer side surface of the battery case corresponding to the first internal lead.

8. The battery of claim 6, wherein
the battery case is cylindrical, and
the indicator is a flat portion provided in part of the outer side surface of the battery case corresponding to the first internal lead.

9. The battery of claim 6, wherein
the indicator is a raised portion which is provided in part of the outer side surface of the battery case corresponding to the first internal lead.

10. The battery of claim 1, wherein
the indicator is provided on an outer bottom surface of the battery case.

11. The battery of claim 10, wherein
the indicator is a weld mark which remains on part of the outer bottom surface of the battery case corresponding to the first internal lead.

12. A battery pack including a plurality of batteries, and a pack case containing the plurality of batteries, each of the plurality of batteries comprising:
an electrode group which includes a positive electrode and a negative electrode wound or stacked with a porous insulating layer interposed therebetween, and is placed in a battery case together with an electrolyte solution, an opening of the battery case being sealed by a sealing plate;
a first internal lead which is electrically connected to one of the positive electrode and the negative electrode, and is connected to an inner bottom surface of the battery case; and
a second internal lead which is electrically connected to the other one of the positive electrode and the negative electrode, and is connected to the sealing plate, wherein
the first internal lead is arranged near an inner side surface of the battery case, and
each of the plurality of batteries is arranged in the pack case in such a manner that part of the outer side surface of the battery case corresponding to the first internal lead faces an inner side surface of the pack case.

13. The battery pack of claim 12, wherein
each of the plurality of batteries is placed in the pack case in such a manner that part of the outer side surface of the battery case corresponding to the first internal lead contacts the inner side surface of the pack case.

14. The battery pack of claim 12, further comprising:
a heat dissipator comprising a heat dissipating member is provided on part of the outer side surface of the battery case corresponding to the first internal lead.

15. The battery pack of claim 12, wherein
the pack case is comprised of a heat dissipating member.

16. The battery pack of claim 12, wherein
each of the plurality of batteries includes an indicator for indicating the position of the first internal lead contained in the battery case.

17. The battery pack of claim 16, wherein
the indicator is provided on an outer surface of the sealing plate.

18. The battery pack of claim 16, wherein
the indicator is provided on an outer side surface of the battery case.

19. The battery pack of claim 16, wherein
the indicator is provided on an outer bottom surface of the battery case.
